(19) United States
(12) Patent Application Publication
(10) Pub. No.: US 2015/0149784 A1
(43) Pub. Date: May 28, 2015

(54) Communication method utilizing fingerprint information authentication

(71) Applicant: WWTT TECHNOLOGY CHINA, Jiangmen, Heshan City (CN)

(72) Inventors: Kwok fong Wong, Heshan (CN); Pui yi Ching, Heshan (CN)

(73) Assignee: WWTT TECHNOLOGY CHINA, Heshan City (CN)

(21) Appl. No.: 13/881,361

(22) PCT Filed: Nov. 10, 2012
(86) PCT No.: PCT/CN2012/084427

§ 371 Date: Apr. 24, 2013

(30) Foreign Application Priority Data
Aug. 21, 2012 (CN) 201210297631.5

(51) Int. Cl. G06K 9/00; H04L 29/06

(52) U.S. Cl. CPC G06K 9/00087; G06K 9/00013; H04L 63/0428
USPC 713/176

(57) ABSTRACT

A communication method utilizing fingerprint information authentication comprises the following steps: (a) extracting fingerprint information of first, and sending a request instruction to second user via the fingerprint information by a first user on an information exchange platform, and extracting fingerprint information of second user after receiving the request by the second user, and storing the fingerprint information in the information exchange platform and exchanging it with first user by the second user to confirm their identity; (b) inputting a message to be sent in an encrypting unit to obtain encrypted message by the first user after passing authentication, and transmitting the encrypted message to a communication application unit and sending it to second user, and receiving the encrypted message via the communication application unit by the second user; (c) decrypting the encrypted message by means of the decrypting unit by the second user after passing authentication.

### FIELD OF THE INVENTION

The invention relates to a communication method utilizing fingerprint information authentication.

### DESCRIPTION OF THE RELATED ART

Currently, most of people always desire some of their messages to be private when they chat by various chat software's or other software's capable of sending instant messages. For example, if two people are chatting with each other by means of a chat software, a third part may glance at the chat content of them if he/she happened to pass by there at that time, or alternatively, some people only wish their messages to be public to somebody when they chat in a group, however, they would like not to chat privately, and the above problem can not be solved by using existing chat software's. Accordingly, there exists an urgent requirement to make the specific messages be read by specific persons to ensure the privacy of chat content or information sent.

### SUMMARY OF THE INVENTION

One object of the invention is to provide a communication method utilizing fingerprint information authentication, according to the invention, the privacy and security of chat can be improved based on the fingerprint authentication and making no modification to the original communication application unit. One technical solution of the invention is in that a communication method utilizing fingerprint information authentication, which comprises the steps of:

(a) extracting fingerprint information of a first user by means of a collection and recognition device of a fingerprint sensor and transmitting the fingerprint information to a information exchange platform, sending a request instruction to a second user through the fingerprint information on the information exchange platform by the first user, and confirming the request after receiving the request instruction by the second user and extracting fingerprint information of the second user by means of the collection and recognition device of the fingerprint sensor, and storing the fingerprint information of the second user in the information exchange platform and exchanging fingerprint information of the second user with the first user to verify their identity;

(b) extracting fingerprint information of the first user and authenticating the first user identity by the collection and recognition device of the fingerprint sensor, inputting a message to be sent in an encrypting unit by the first user after passing the authentication, to obtain an encrypted message, and then transmitting the encrypted message to a communication application unit and sending it to the second user, and receiving the encrypted message via the communication application unit by the second user;

(c) extracting fingerprint information of the second user and authenticating the identity of the second user by the collection and recognition device of the fingerprint sensor, and decrypting the encrypted message by means of a decrypting unit and reading the decrypted message by the second user after passing the authentication.

Preferably, in step (a), extracting fingerprint information of the first user by means of the collection and recognition device of the fingerprint sensor and generating a first public key and a first private key corresponding to each other, storing the first private key in a memory of the fingerprint sensor and storing the first public key in the information exchange platform, and sending a request instruction to the second user via the first public key by the first user, and confirming the request after receiving the request instruction by the second user and extracting fingerprint information of the second user by means of the collection and recognition device of the fingerprint sensor and generating a second public key and a second private key, storing the second private key in the memory of the fingerprint sensor, storing the second public key in the information exchange platform and exchanging the second public key with the first public key of the first user;

In step (b), extracting fingerprint information of the first user by means of the collection and recognition device of the fingerprint sensor, and comparing the fingerprint information to the first private key stored in the memory of the fingerprint sensor in step (a), and if consistent, the first user passing the authentication;

In step (c), extracting fingerprint information of the second user by means of the collection and recognition device of the fingerprint sensor, and comparing the fingerprint information to the second private key stored in the memory of the fingerprint sensor in step (a), and if consistent, the second user passing the authentication.

More preferably, the information exchange platform is a host computer or server.

More preferably, the communication application unit can be selected from the group of microblog, QQ, MSN, SKYPE or any combination thereof.

Still other preferably, information transmission between the first user and the second user can be achieved by any one of network, infrared, Bluetooth or any combination thereof.

By utilizing the above method, encryption and decryption management can be carried out with fingerprint information by people, and thus any people without the specific fingerprint can not read the encrypted messages, thereby making the privacy and security of user information improved greatly.

### BRIEF DESCRIPTION OF THE DRAWINGS

FIG. 1 is a flow chart of step (a) of exchanging fingerprint information according to the invention;

FIG. 2 is a flow chart of step (b) of encrypting and sending messages according to the invention;

FIG. 3 is a flow chart of step (c) of decrypting and reading messages according to the invention;

FIG. 4 is a schematic block diagram of step (a) of exchanging fingerprint information according to the invention.

### DETAILED DESCRIPTION OF THE INVENTION

Preferred embodiments of the present invention will now be described in more detail hereinafter with reference to the drawings, so that the advantages and features of the invention can be easily understood by a person skilled in the art, thereby the protection scope of the invention can be defined more clearly.

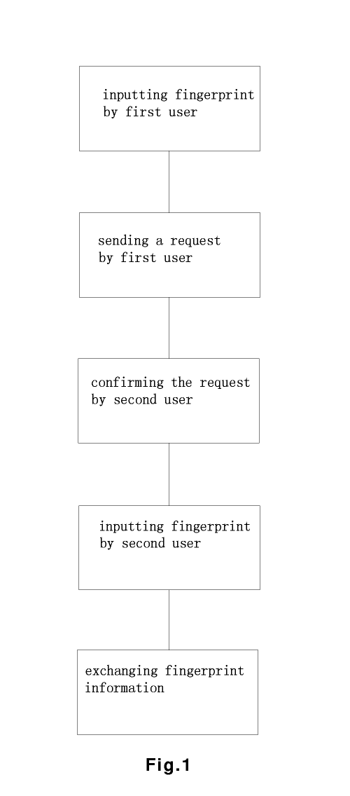

FIGS. 1-4 show a communication method utilizing fingerprint information authentication, which comprises the following steps:

(a) exchanging fingerprint information

As shown in FIGS. 1-4, first user extracts and transmits fingerprint information thereof to a information exchange platform by means of a collection and recognition device of a fingerprint sensor, and the first user sends a request instruction to a second user through the fingerprint information on the information exchange platform, and the second user confirms the request after receiving the request instruction and extracts fingerprint information thereof by means of the collection and recognition device of a fingerprint sensor, and the second user stores fingerprint information thereof in the information exchange platform and exchanges fingerprint information with the first user to verify their identity.

(b) encrypting and sending messages

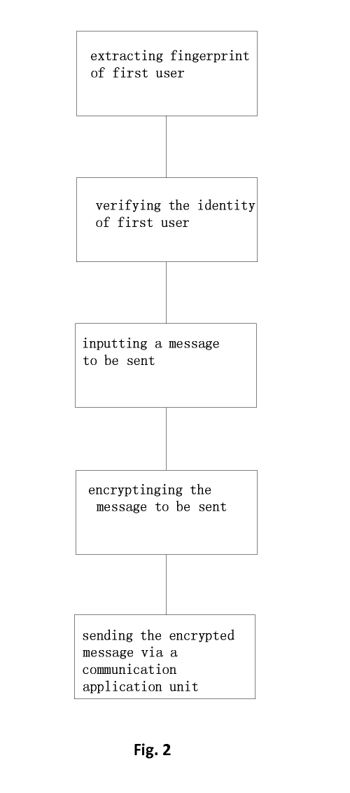

As shown in FIG. 2, the first user extracts fingerprint information thereof by the collection and recognition device of the fingerprint sensor, the first user inputs a message to be sent in an encrypting unit after passing the authentication, and encrypts the message by means of the encrypting unit, and then transmits the encrypted message to a communication application unit and further sends it to the second user, and the second user receives the encrypted message via the communication application unit.

(c) decrypting and reading messages

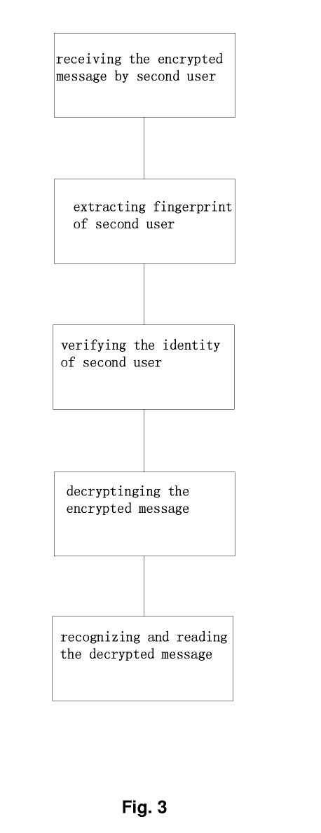

As shown in FIG. 3, the second user extracts fingerprint information thereof by the collection and recognition device of the fingerprint sensor, and the second user decrypts the message by means of a decryption unit after passing the authentication.

In this embodiment, the fingerprint sensor includes a collection and recognition device and a memory. The collection and recognition device is used for extracting fingerprint information, and capable of comparing the extracted fingerprint information to the fingerprint information stored in the memory and carrying out authentication. And the memory is used for storing fingerprint authentication information and private keys for encrypting and decrypting messages

The information exchange platform interconnects with the fingerprint sensor, and the information exchange platform is used for exchanging information between users to achieve the purpose of exchanging public keys and finishing the identity verification of users, which can be a host computer, or a network server.

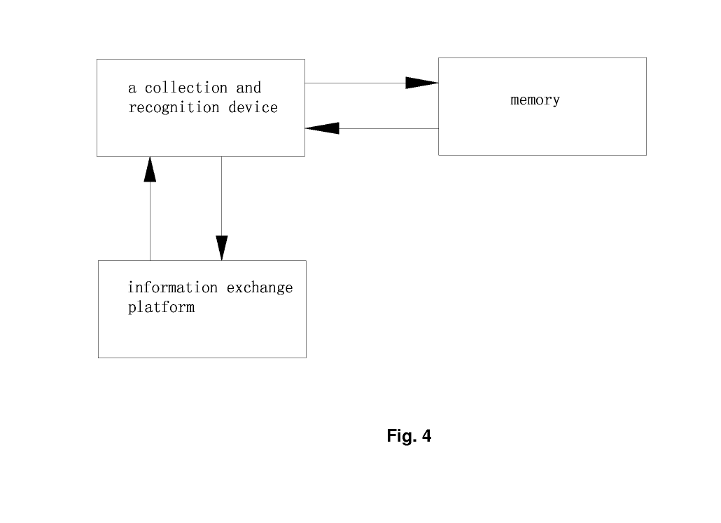

As shown in FIGS. 1 and 4, a collection and recognition device of a fingerprint sensor extracts the fingerprint information of the first user and generates a first public key and a first private key corresponding to each other, and the first private key is stored in a memory of the fingerprint sensor and the first public key is stored in a information exchange platform, and the first user sends a request instruction to a second user via the first public key in the information exchange platform, and the second user confirms the request after receiving the request instruction and extracts fingerprint information thereof by means of the collection and recognition device of the fingerprint sensor to generate a second public key and a second private key, the second private key is stored in the memory of the fingerprint sensor, and the second public key is stored in the information exchange platform and exchanged with the first public key of the first user.

As shown in FIG. 2, the encrypting unit can be provided on the fingerprint sensor, or alternatively configured as various other encryption means. The encrypting unit encrypts the messages to be sent with fingerprint information, and the encrypted messages will become texts of various forms such as messy codes, codes, and figures, which can not be read normally before decryption, thus, the encrypted messages can not be read before decryption.

The collection and recognition device of the fingerprint sensor extracts fingerprint information of the first user, and compares the fingerprint information to the first private key stored in the memory of the fingerprint sensor in step (a). If different, the first user can not perform next operations without passing authentication.

If consistent, the first user can input messages to be sent in the encryption unit after passing authentication, and the encryption unit encrypts the messages to be sent to obtain the encrypted messages. The first user inputs the encrypted messages to the communication application unit and send the messages to the second user, the second user receive the encrypted messages via the communication application unit.

The communication application unit can be various chat software's or other various applications of instant messages, such as microblog, QQ, MSN, SKYPE or the like.

As shown in FIG. 3, the collection and recognition device of the fingerprint sensor extracts fingerprint information of the second user, and compares the fingerprint information to the second private key stored in the memory of the fingerprint sensor in step (a). If different, the second user can not perform next operations without passing authentication. If consistent, the second user passes the authentication. And thus the second user can decrypt the received encrypted messages by using the decrypting unit. The decrypting software corresponds to the encryption software, and is capable of recognizing information adversely.

After decryption, the original messy codes or figures can recombine into characters of normal font automatically, or alternatively, a mouse is in any position on characters of messy codes, and the messy codes in the position will become characters of normal or enlarged characters. Accordingly, even if other users operate at the second user end, the chat content can not be decrypted because they don't have the fingerprint information of the second user. Thus, the communication method disclosed in the invention improves the security greatly.

It is to be noted, however, that only the preferred embodiments are illustrated with reference to the accompanying drawings herein and which should not to be considered limiting of the invention, furthermore, it should be appreciated for a person skilled in the art that various modifications or variations can be made to the invention without departing from the spirit and protecting scope of the present invention, and such variations or variations would be covered within the protection scope of the invention.

What is claimed is:

1. A communication method utilizing fingerprint information authentication, comprising the steps of:
(a) extracting fingerprint information of a first user by means of a collection and recognition device of a fingerprint sensor and transmitting the fingerprint information to a information exchange platform, sending a request instruction to a second user through the fingerprint information on the information exchange platform by the first user, and confirming the request after receiving the request instruction by the second user and extracting fingerprint information of the second user by means of the collection and recognition device of the fingerprint sensor, and storing the fingerprint information of the second user in the information exchange platform and exchanging the fingerprint information of the second user with the first user to verify their identity;
(b) extracting fingerprint information of the first user and authenticating the identity of the first user by the collection and recognition device of the fingerprint sensor, inputting a message to be sent in an encrypting unit by the first user after passing the authentication, to obtain an encrypted message, and then transmitting the encrypted message to a communication application unit and sending it to the second user, and receiving the encrypted message via the communication application unit by the second user;
(c) extracting fingerprint information of the second user and authenticating the identity of the second user by the collection and recognition device of the fingerprint sensor, and decrypting the encrypted message by means of a decrypting unit and reading the decrypted message by the second user after passing the authentication.

2. The communication method utilizing fingerprint information authentication as claimed in claim 1, wherein
in step (a), extracting fingerprint information of the first user by means of the collection and recognition device of the fingerprint sensor and generating a first public key and a first private key corresponding to each other, storing the first private key in a memory of the fingerprint sensor and storing the first public key in the information exchange platform, and sending a request instruction to the second user via the first public key by the first user, and confirming the request after receiving the request instruction by the second user and extracting fingerprint information of the second user by means of the collection and recognition device of the fingerprint sensor and generating a second public key and a second private key, storing the second private key in the memory of the fingerprint sensor, storing the second public key in the information exchange platform and exchanging the second public key with the first public key of the first user;
in step (b), extracting fingerprint information of the first user by means of the collection and recognition device of the fingerprint sensor, and comparing the fingerprint information to the first private key stored in the memory of the fingerprint sensor in step (a), and if consistent, the first user passing the authentication;
in step (c), extracting fingerprint information of the second user by means of the collection and recognition device of the fingerprint sensor, and comparing the fingerprint information to the second private key stored in the memory of the fingerprint sensor in step (a), and if consistent, the second user passing the authentication.

3. The communication method utilizing fingerprint information authentication as claimed in claim 1, wherein the information exchange platform is a host computer or server.

4. The communication method utilizing fingerprint information authentication as claimed in claim 1, wherein the communication application unit is selected from the group of micro blog, QQ, MSN, SKYPE or any combination thereof.

5. The communication method utilizing fingerprint information authentication as claimed in claim 1, wherein information transmission between the first user and the second user via the communication application unit can be achieved by any one of network, infrared, Bluetooth or any combination thereof.
